(19) United States
(12) Patent Application Publication
(10) Pub. No.: US 2016/0301131 A1
(43) Pub. Date: Oct. 13, 2016

(54) ARRAY ANTENNA DEVICE

(71) Applicant: KABUSHIKI KAISHA TOSHIBA, Tokyo (JP)

(72) Inventors: Makoto HIGAKI, Setagaya Tokyo (JP); Koh HASHIMOTO, Yokohama Kanagawa (JP); Manabu MUKAI, Yokohama Kanagawa (JP)

(73) Assignee: KABUSHIKI KAISHA TOSHIBA, Tokyo (JP)

(21) Appl. No.: 14/872,875

(22) Filed: Oct. 1, 2015

(30) Foreign Application Priority Data
Apr. 7, 2015 (JP) 2015-078524

(51) Int. Cl. H01Q 3/08; H01Q 21/00

(52) U.S. Cl. CPC H01Q 3/08; H01Q 21/0006

(57) ABSTRACT

An array antenna device according to an embodiment has a first sub-array antenna and a second sub-array antenna, a driver, and a feeder. The first sub-array antenna and the second sub-array antenna have a plurality of radiating elements arranged in a reference plane. The driver, by changing the orientation of at least one of the first sub-array antenna and the second sub-array antenna, causes the normal lines of the reference planes of the first sub-array antenna and the second sub-array antenna to intersect. The feeder performs in-phase power feed to the first sub-array antenna and the second sub-array antenna, and performs opposite-phase power feed to the first sub-array antenna and the second sub-array antenna.

### CROSS-REFERENCE TO RELATED APPLICATION

This application is based upon and claims the benefit of priority from Japanese Patent Application No. 2015-078524, filed Apr. 7, 2015; the entire contents of which are incorporated herein by reference.

### FIELD

Embodiments described herein relate to an array antenna device.

### BACKGROUND

An array antenna device in which a plurality of radiating elements are disposed in a two-dimensional matrix has been known. In this array antenna device, there are cases of using a null formed by opposite-phase synthesizing of a plurality of sub-arrays for the purpose of accurately capturing the party to be communicated with or searched for. However, if the directional gain of the array antenna device is set to be high, the change in accordance with the null angle may be steep and the null angular width may be narrow, compared to the mechanical accuracy of the drive mechanism that changes the mechanical direction of the overall antenna. If the mechanical accuracy of the drive mechanism becomes relatively insufficient because of the null becoming excessively steep and narrow, it might become difficult to capture a party to be communicated with or searched for.

### BRIEF DESCRIPTION OF THE DRAWINGS

FIG. 1 is an oblique view showing, in schematic form, the constitution of an array antenna device of an embodiment.

FIG. 2 is a cross-sectional view showing an example of a change in the orientation of the first antenna unit and the second antenna unit of the array antenna device of the embodiment.

FIG. 3 is a drawing showing a part of the directional gain and an enlarged part thereof in the vicinity of the forward direction when in-phase feed is done with a preset angle of α=0° in the array antenna device of the embodiment.

FIG. 4 is a drawing showing a part of the directional gain and an enlarged part thereof in the vicinity of the forward direction when opposite-phase feed is done with a preset angle of α=0° in the array antenna device of the embodiment.

FIG. 5 is a drawing showing a part of the directional gain and an enlarged part thereof in the vicinity of the forward direction when in-phase feed is done with a preset angle of α=3.2° in the array antenna device of the embodiment.

FIG. 6 is a drawing showing a part of the directional gain and an enlarged part thereof in the vicinity of the forward direction when opposite-phase feed is done with a preset angle of α=3.2° in the array antenna device of the embodiment.

FIG. 7 is a drawing showing a part of the directional gain and an enlarged part thereof in the vicinity of the forward direction when in-phase feed is done with a preset angle of α=5° in the array antenna device of the embodiment.

FIG. 8 is a drawing showing a part of the directional gain and an enlarged part thereof in the vicinity of the forward direction when opposite-phase feed is done with a preset angle of α=5° in the array antenna device of the embodiment.

FIG. 9 is an oblique view showing, in schematic form, the constitution of an array antenna device according to a variation example of the embodiment.

FIG. 10 is a cross-sectional view showing an example of a change in the orientation of the third antenna unit and the fourth antenna unit of the array antenna device of the variation example of the embodiment.

### DETAILED DESCRIPTIONS

An array antenna device according to an embodiment has a first sub-array antenna and a second sub-array antenna, a driver, and a feeder. The first sub-array antenna and the second sub-array antenna have a plurality of radiating elements arranged in a reference plane. The driver, by changing the orientation of at least one of the first sub-array antenna and the second sub-array antenna, causes the normal lines of the reference planes of the first sub-array antenna and the second sub-array antenna to intersect. The feeder performs in-phase power feed to the first sub-array antenna and the second sub-array antenna, and performs opposite-phase power feed to the first sub-array antenna and the second sub-array antenna.

An array antenna device according to an embodiment will be described below, with references made to the drawings.

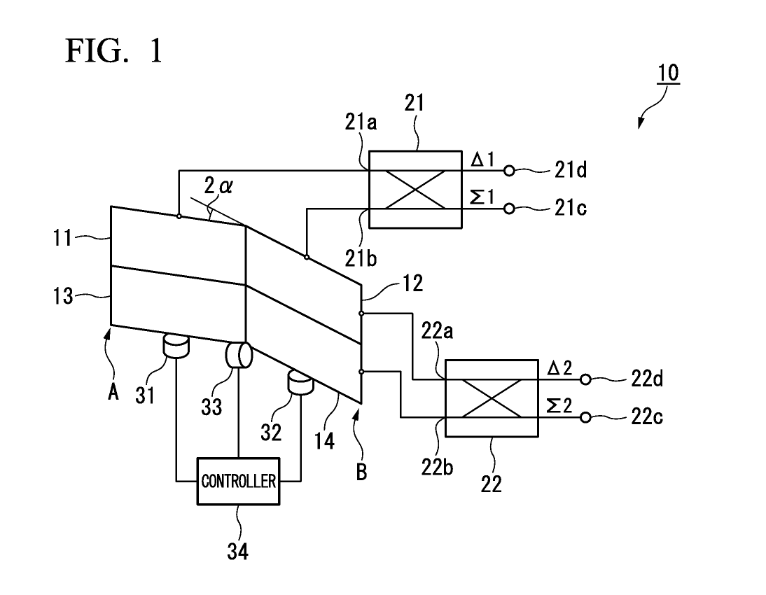

An array antenna device 10 of the present embodiment, as shown in FIG. 1, has four sub-array antennas 11, . . . , 14, two hybrid circuits 21 and 22, three drivers 31, 32, and 33, and a controller 34.

The four sub-array antennas 11, . . . , 14 are the first sub-array antenna 11, the second sub-array antenna 12, the third sub-array antenna 13, and the fourth sub-array antenna 14. Each of the four sub-array antennas 11, 14 has a plurality of radiating elements is disposed in a two-dimensional matrix. In each of the four sub-array antennas 11, . . . , 14, the plurality of radiating elements is disposed on a planar reference plane. Each of the four sub-array antennas 11, . . . , 14 has an amplitude distribution that is uniform, tailored, or some other distribution to cause, for example, the radio wave radiation intensity in the vertical direction increases.

The first sub-array antenna 11, the second sub-array antenna 12, the third sub-array antenna 13, and the fourth sub-array antenna 14 are arranged in a two-row, two-column matrix. The first sub-array antenna 11 and the third sub-array antenna 13 form the first antenna A. In the first antenna A, the first sub-array antenna 11 and the third sub-array antenna 13 are arranged so as to be neighboring, so that their reference planes form a reference plane SA in the same plane. The second sub-array antenna 12 and the fourth sub-array antenna 14 form the second antenna 13. In the second antenna B, the second sub-array antenna 12 and the fourth sub-array antenna 14 are arranged so as to be neighboring, so that their reference planes form a reference plane SB in the same plane.

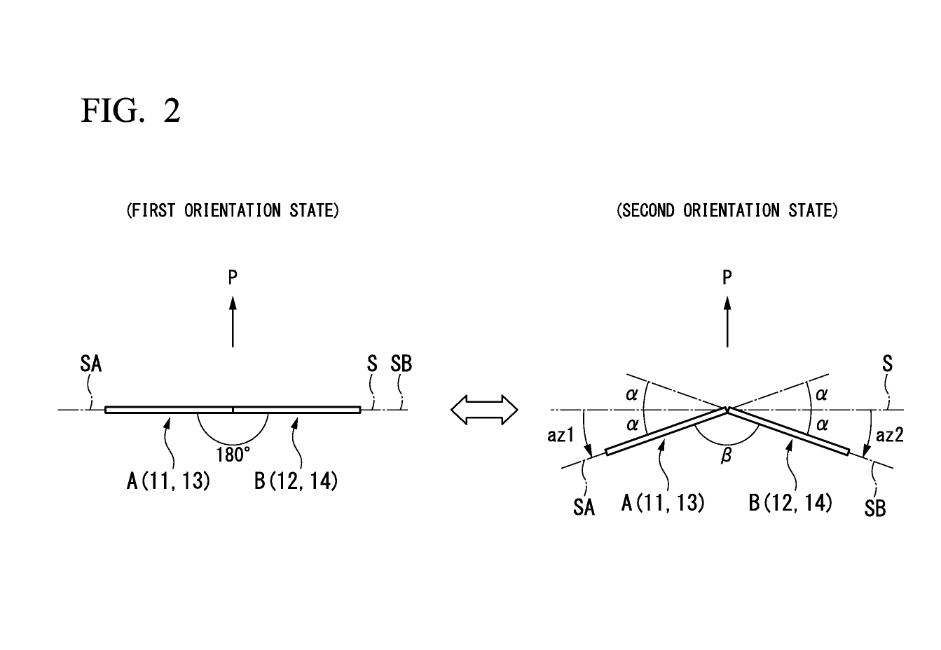

The orientations of the first antenna A and the second antenna B, as shown in FIG. 2, are switched between a first orientation state and a second orientation state. In the first orientation state, the reference plane SA of the first antenna A and the reference plane SB of the second antenna B form the same plane S. In the second orientation state, the normal lines of the reference plane SA of the first antenna A and the reference plane SB of the second antenna B mutually intersect. In the second orientation state, the reference plane SA of the first antenna A is inclined with respect to the reference plane SB of the second antenna B by an acute angle greater than zero. In the second orientation state, the angle formed by the reference plane SA of the first antenna A and the reference plan SB of the second antenna B is an acute angle greater than zero.

The first orientation state is a state, for example, in which normal line directions of the reference plane SA of the first antenna A and normal line directions of the reference plane SB of the second antenna B coincide with the forward direction P.

The second orientation state is a state, for example, in which the first antenna A and the second antenna B are disposed to cause the outer shapes of the reference plane SA of the first antenna A and the reference plane SB of the second antenna B protrude in the forward direction P. The reference plane SA of the first antenna A and the reference plane SB of the second antenna B are inclined from the plane S, in which the normal directions coincide with the forward direction P, rearward to the azimuth directions az1 and az2 by a preset angle α in mutually opposite directions. The double the preset angle alpha (2α) is the difference between 180 degrees and the reference angle β. The reference plane SA of the first antenna A is inclined with respect to the reference plane SB of the second antenna B by an angle that is double the preset angle alpha (2α). The preset angle α is, for example, the angle between the first null angle θ1 and the second null angle θ2.

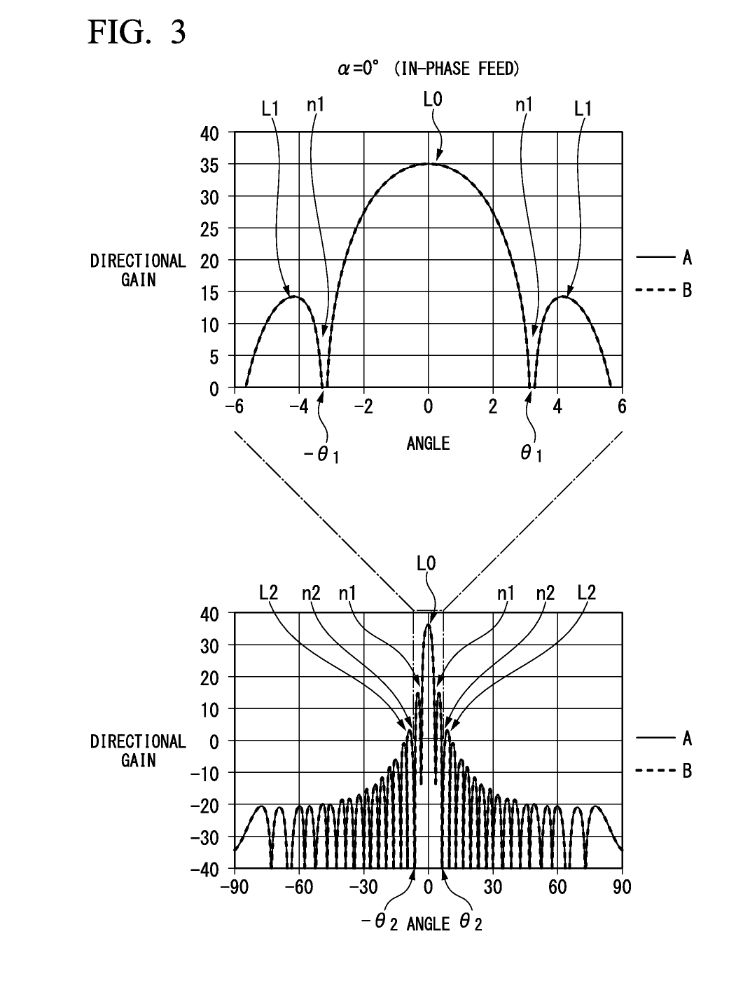

The first null angle θ1, as shown in FIG. 3, is the angle at the minimum point (first null) n1 between the main lobe L0 and a first side lobe L1 of the directional gain when the first antenna A and the second antenna B in the first orientation state are fed in-phase. The second null angle θ2 is the angle at the minimum point (second null) n2 between the first side lobe L1 and a second side lobe L2.

The two hybrid circuits 21 and 22 are the first hybrid circuit 21 and the second hybrid circuit 22, which are 180° hybrid circuits and have the same constitution. Each of them outputs a sum signal Σ that is the sum of input signals input to two input terminals added by in-phase feed and a difference signal Δ that is the difference between input signals input to two input terminals subtracted by opposite-phase feed.

The first input terminal 21a of the first hybrid circuit 21 is connected to the first sub-array antenna 11 and the third sub-array antenna 13. The second input terminal 21b of the first hybrid circuit 21 is connected to the second sub-array antenna 12 and the fourth sub-array antenna 14. The first output terminal 21c of the first hybrid circuit 21 outputs a first sum signal Σ1 of each of the output signals from the first sub-array antenna 11, the second sub-array antenna 12, the third sub-array antenna 13, and the fourth sub-array antenna 14. The second output terminal 21d of the first hybrid circuit 21 outputs a first difference signal Δ1 of the difference between the output signals of the first sub-array antenna 11 and the third sub-array antenna 13 and the output signals of the second sub-array antenna 12 and the fourth sub-array antenna 14.

The first input terminal 22a of the second hybrid circuit 22 is connected to the first sub-array antenna 11 and the second sub-array antenna 12. The second input terminal 22b of the second hybrid circuit 22 is connected to the third sub-array antenna 13 and the fourth sub-array antenna 14. The first output terminal 22c of the second hybrid circuit 22 outputs a second sum signal Σ2 of each of the output signals from the first sub-array antenna 11, the second sub-array antenna 12, the third sub-array antenna 13, and the fourth sub-array antenna 14. The second output terminal 22d of the second hybrid circuit 22 outputs a second difference signal Δ2 of the difference between the output signals of the first sub-array antenna 11 and the second sub-array antenna 12 and the output signals of the third sub-array antenna 13 and the fourth sub-array antenna 14.

The three drivers 31, 32, and 33 are the first driver 31, the second driver 32, and the third driver 33. The first driver 31 drives the first sub-array antenna 11 and the third sub-array antenna 13 of the first antenna A as a whole. The second driver 32 drives the second sub-array antenna 12 and the fourth sub-array antenna 14 of the second antenna 13 as a whole. The first driver 31 and the second driver 32, for example, change the orientation of the first antenna A and the second antenna B in the azimuth direction. The third driver 33 provides overall drive to the first sub-array antenna 11, the second sub-array antenna 12, the third sub-array antenna 13, and the fourth sub-array antenna 14. The third driver 33, for example, changes the overall elevation angle orientation of the first sub-array antenna 11, the second sub-array antenna 12, the third sub-array antenna 13, and the fourth sub-array antenna 14.

The three drivers 31, 32, and 33 can be implemented, for example, by a component such as a motor, which is capable of converting electrical energy to mechanical energy to cause rotation. If necessary, a drive circuit may be provided for applying to the motor an appropriate voltage or current in accordance with a specified angle of rotation.

The controller 34 performs overall control of the operation of the array antenna device 10, and has a processor such as a CPU, a ROM to store a program, and RAM or the like for temporary storage of data.

By controlling the first driver 31 and the second driver 32, the controller 34 switches the orientations of the first antenna A and the second antenna B between the first orientation state and the second orientation state.

By controlling the first driver 31 and the second driver 32, the controller 34 changes the overall directivity orientation of the first sub-array antenna 11, the second sub-array antenna 12, the third sub-array antenna 13, and the fourth sub-array antenna 14.

The controller 34, in accordance with the orientation of the first antenna A and the second antenna B and the feed state of the first hybrid circuit 21, switches and executes a first mode and a second mode. In the first mode, the controller 34 places the first antenna A and the second antenna B into the first orientation state by the first driver 31 and the second driver 32. In the first mode, the controller 34, using the first sum signal El output from the first output terminal 21c of the first hybrid circuit 21 using in-phase feed, performs communication or searching. In the second mode, the controller 34 places the first antenna A and the second antenna B into the second orientation state by the first driver 31 and the second driver 32 and, using the first difference signal Δ1 output from the second output terminal 21d of the first hybrid circuit 21 by in-phase feed, captures the party being communicated with or the party being searched for.

When communicating with a desired party or searching for a desired party, the controller 34 first captures the party with which communication is to be done or the party to be searched for by executing the second mode. The controller 34 changes the overall directivity orientation of the first antenna A and the second antenna B by the first driver 31 and the second driver 32, to cause a signal of the party being communicated with or party being searched for does not appear at the main null n0 in the forward direction P of the first difference signal Δ1 when the second mode is executed. When the controller 34 changes the overall directivity orientation of the first antenna A and the second antenna B, the first antenna A and the second antenna B are maintained in the second orientation state. The controller 34 changes the overall directivity orientation of the first antenna A and the second antenna B, while maintaining the condition in which the reference plane SA of the first antenna A is inclined with respect to the reference plan SB of the second antenna B by an angle that is double the preset angle α (2α).

Next, the controller 34, by executing the first mode, communicates with or searches for the desired party. The controller 34 makes the orientation of the first antenna A and the second antenna B the first orientation state, while maintaining the overall directivity orientation of the first antenna A and the second antenna B set at the time of executing the second mode, using the first driver 31 and the second drive 32. The controller 34 performs communication or searching, using a signal related to the communicating party or party to be searched for appearing at the main lobe in the forward direction P of the first sum signal Σ1 when the first mode is executed.

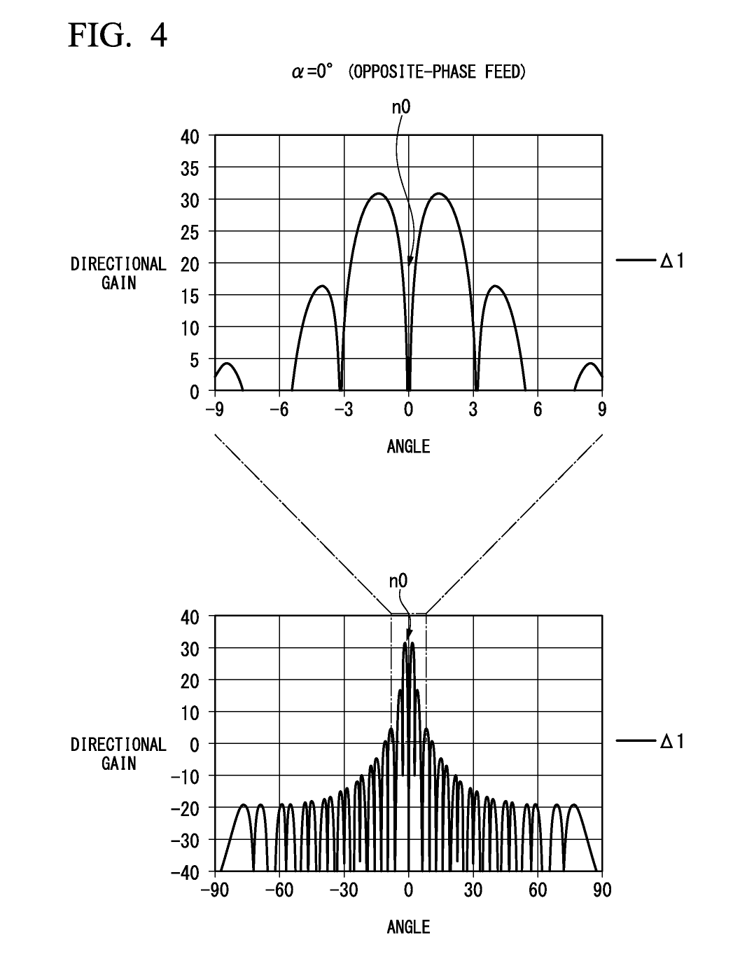

The controller 34, for example, in the condition in which the first antenna A and the second antenna B are maintained in the first orientation state, executes the second mode if the main null n0 in the forward direction P of the first difference signal Δ1 is steeper and narrower than a preset degree. The controller 34, as shown in FIG. 4, executes the second mode if the change and angle width in response to the null n0 angle with the first antenna A and the second antenna B in the first orientation state are excessively steep and narrow relative to the mechanical accuracy of the first driver 31 and the second driver 32.

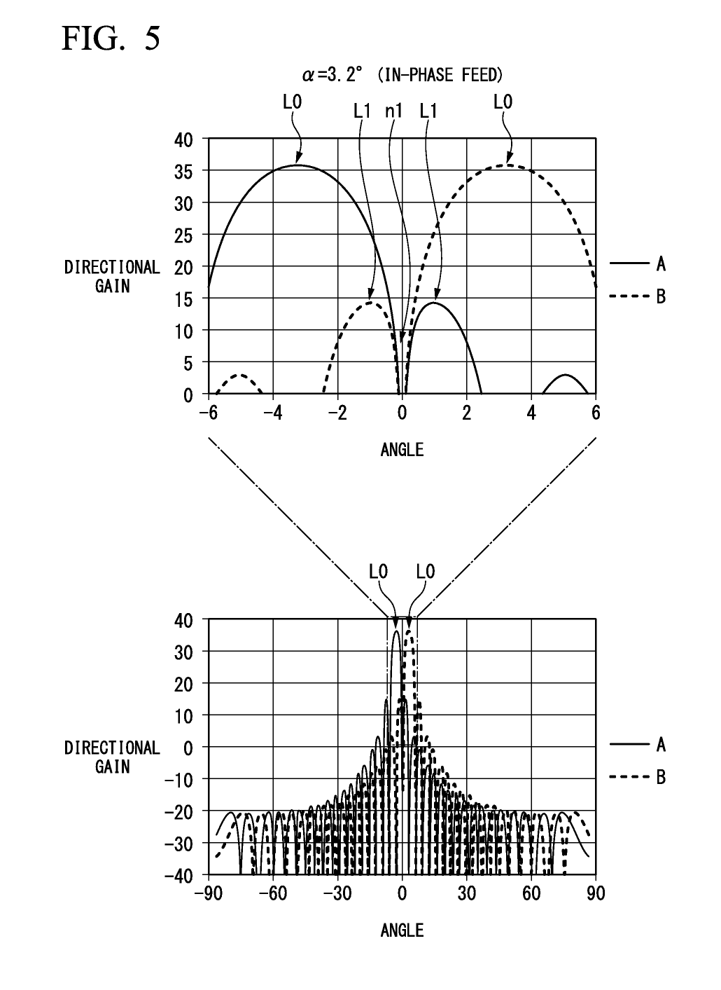

The controller 34 stores data of the preset angle α into memory beforehand. The controller 34, for example, stores the first null angle θ1 (3.2°) as the preset angle α. The controller 34, as shown in FIG. 5, by placing the first antenna A and the second antenna B into the second orientation state using the preset angle α, it shifts the angle dependence of the directional gain of the first antenna A and the second antenna 13 mutually in opposite directions by the amount of the first null angle θ1. In the directional gain shown in FIG. 5, a first null n1 of each of the first antenna A and the second antenna B occurs at the forward direction P at the angle of zero.

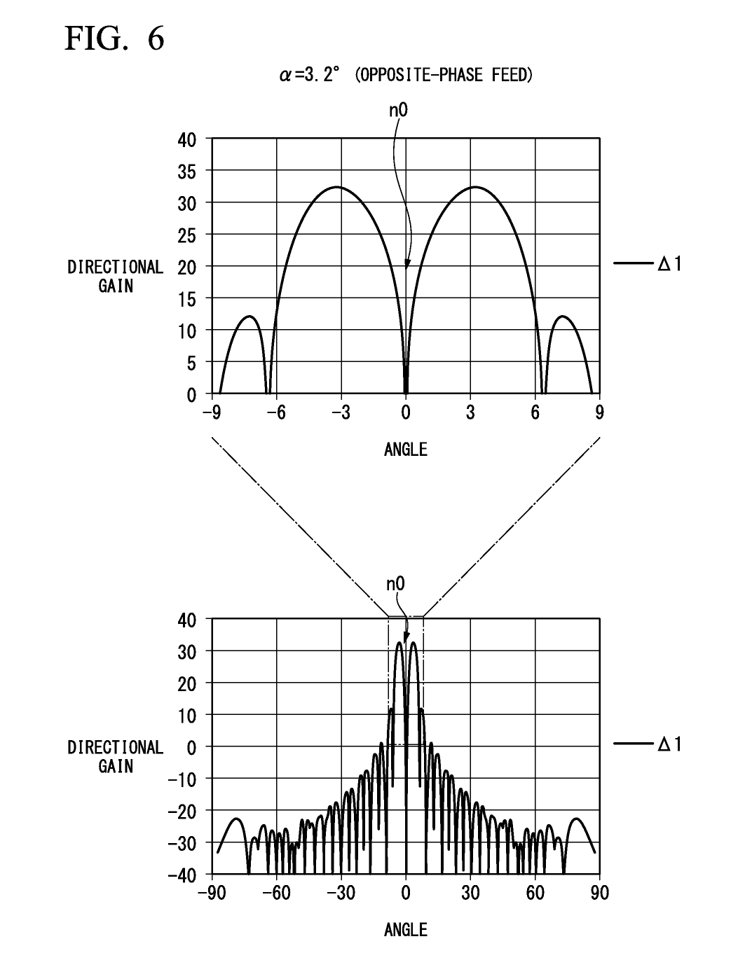

The main null n0 in the forward direction P of the first difference signal Δ1 for the case in which the first antenna A and the second antenna B are in the second orientation state, as shown in FIG. 6, is gentler and wider than when the first antenna A and the second antenna B are in the first orientation state. By executing the second mode, the controller 34 prevents the change and the angle width in response to the null n0 angle from being excessively steep and narrow compared to the mechanical accuracy of the first driver 31 and the second driver 32.

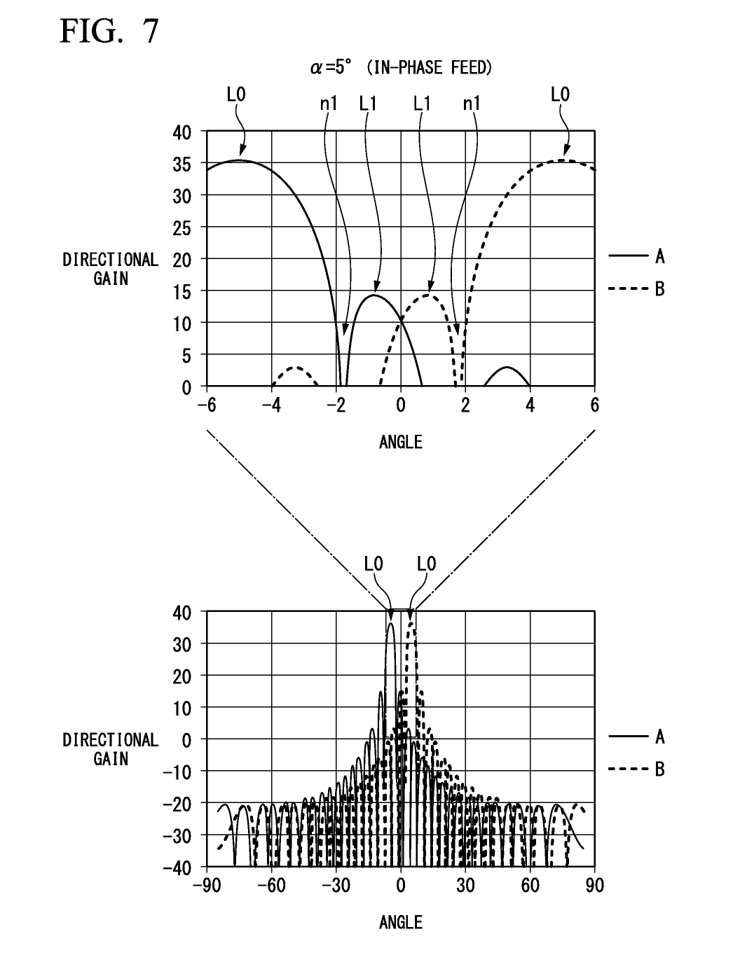

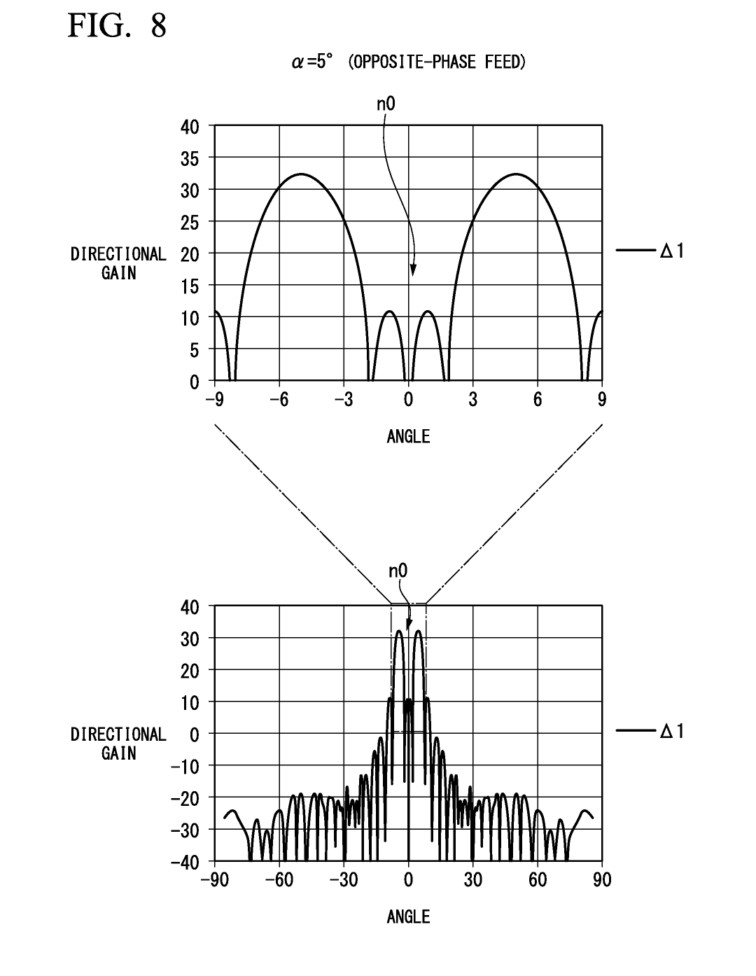

The controller 34, for example, stores as the preset angle α an angle in the range between the first null angle θ1 and the second null angle θ2. FIG. 7 and FIG. 8 show the directional gain of the first antenna A and the second antenna B and the directional gain of the first difference signal Δ1 for the case in which the preset angle α is a preset angle (5°) between the first null angle θ1 and the second null angle θ2. In the directional gain shown in FIG. 7, by placing the first antenna A and the second antenna B into the second orientation state, there is partial overlap between the first side lobes L1 of the first antenna A and the second antenna B in the forward direction P at the angle of zero.

The main null n0 in the forward direction P of the first difference signal Δ1 for the case in which the first antenna A and the second antenna B are in the second orientation state, as shown in FIG. 8, is wider than when the preset angle α is the first null angle θ1. By setting the preset angle α to a preset angle (5°) between the first null angle θ1 and the second null angle θ2, the controller 34 prevents the width of the angle of the null n0 from becoming excessively narrow compared to the mechanical accuracy of the first driver 31 and the second driver 32.

When the preset angle α exceeds the second null angle θ2, a peak that becomes noise increases in the main null n0 in the forward direction P of the first difference signal Δ1 for the case in which the first antenna A and the second antenna B are in the second orientation state.

According to the above-described embodiment, by having the first driver 31 and the second driver 32 that place the first antenna A and the second antenna B into the second orientation state, it is possible to make the normal lines of the reference planes SA and SB of the first antenna A and the second antenna B intersect each other. By having the first hybrid circuit 21 that switches between in-phase feed and opposite-phase feed of the first antenna A and the second antenna B, it is possible to perform opposite-phase feed of the first antenna A and the second antenna B in the second orientation state. By having the controller 34 that executes the second mode, it is possible to prevent the change and the angle width in response to the main null n0 angle in the forward direction P of the first difference signal Δ1 from becoming excessively steep and narrow compared to the mechanical accuracy of the first driver 31 and the second driver 32. By having the controller 34 that executes the second mode, when using the main null n0 of the first different signal Δ1 to capture a party to be communicated with or search for a desired party, it is possible to accurately and properly capture the party to be communicated with or searched for. By having the controller 34 that executes the second mode, compared to the case of placing the first antenna A and the second antenna B in the first orientation state, it is possible to capture a party to be communicated with or searched for by a coarser angular resolution, thereby preventing the time required for capture from being long.

Because of having the controller 34 that switches the first antenna A and the second antenna B between the first orientation state and the second orientation state, it is possible to implement formation of the main beam with a high gain and to form the null n0 that mediates the demand with respect to mechanical accuracy of the first driver 31 and the second driver 32. By having the controller 34 that executes the first mode after execution of the second mode, after capturing the party to be communicated with or party to be searched for, it is possible by the high-gain main beam to improve the rate of communication with the party to be communicated with or the rate of recognition of a party to be searched for.

By having the controller 34 that makes the preset angle α an angle in the range from the first null angle θ1 to the second null angle θ2, it is possible to capture a desired party to communicate with or to search for accurately, using the main null n0 of the first difference signal Δ1. If the preset angle α becomes larger than the second null angle θ2, a peak that becomes noise increases in the main null n0 of the first difference signal Δ1, and it is not possible to capture a desired party to communicate with or to search for accurately.

A variation example will now be described.

In the above-described embodiment, although in the second orientation state, the reference plane SA of the first antenna A and the reference plane SB of the second antenna B were inclined from the plane S by the same preset angle α, this is not a restriction.

In the variation example of the present embodiment, the angle of inclination α1 of the azimuth direction az1 of the reference plane SA of the first antenna A with respect to the plane S and the angle of inclination α2 of the azimuth direction az2 of the reference plane SB of the second antenna B with respect to the plane S may be different.

In the above-described embodiment, although the outer shapes of the reference plane SA of the first antenna A and the reference plane SB of the second antenna B protrude toward the forward direction P, this is not a restriction.

In a variation example of the present embodiment, the second orientation state may be a shape in which the outer shapes of the reference plane SA of the first antenna A and the reference plane SB of the second antenna B protrude rearward, which is the direction opposite from the forward direction P. The reference plane SA of the first antenna A and the reference plane SB of the second antenna B, for example, are inclined from the plane S by the same preset angle α in opposite azimuth directions toward the forward direction from the plane S.

Although in the above-described embodiment the orientations in the azimuth direction of the first antenna A and the second antenna B are switched between the first orientation state and the second orientation state, this is not a restriction.

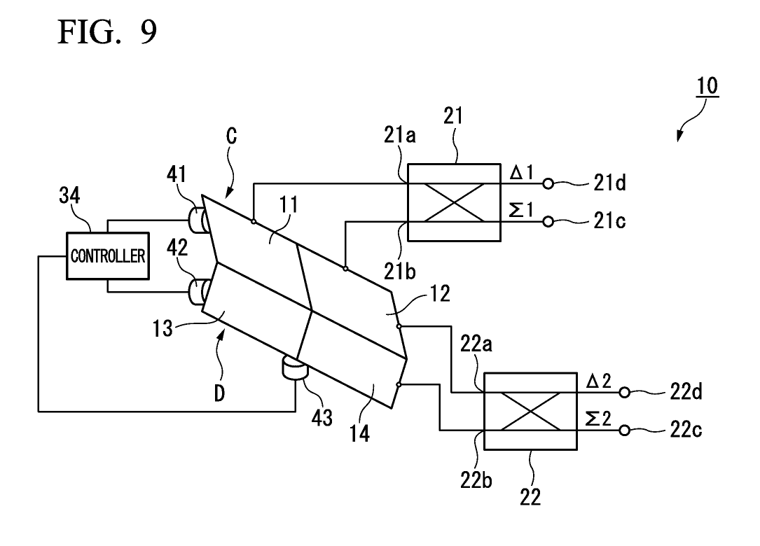

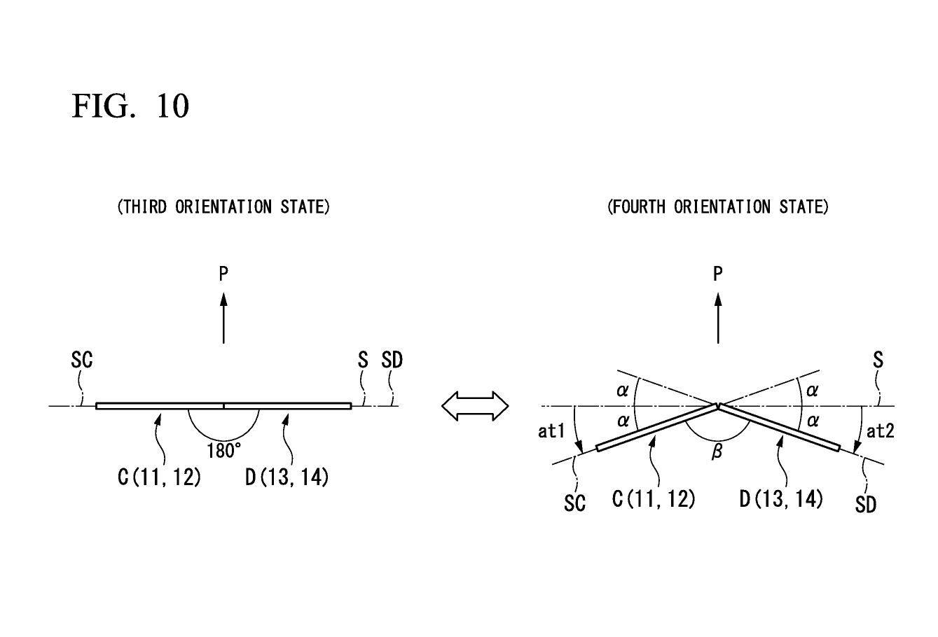

In a variation example of the present embodiment, the elevation angle orientation of the third antenna C and the fourth antenna D may be switched between a third orientation state and a fourth orientation state. The third antenna C has, as shown in FIG. 9, a first sub-array antenna 11 and a second sub-array antenna 12. The fourth antenna D has a third sub-array antenna 13 and a fourth sub-array antenna 14. In the third orientation state, as shown in FIG. 10, the reference plane SC of the third antenna C and the reference plane SD of the fourth antenna D form the same plane S. In the fourth orientation state, the normal lines of the reference plane SC of the third antenna C and the reference plane SD of the fourth antenna D mutually intersect. In the fourth orientation state, for example, the third antenna C and the fourth antenna D are disposed so that the outer shapes of the reference plane SC of the third antenna C and the reference plane SD of the fourth antenna D protrude toward the front direction P. The front direction P refers a direction in which the array antenna device 10 is designed to maximize the gain. The reference plane SC of the third antenna C and the reference plane SD of the fourth antenna D are inclined from the plane S by the same preset angle a at the elevation directions at1 and at2 mutually opposite toward the rear from the plane S in which the normal directions coincide with the front direction P.

In the variation example of the present embodiment, the array antenna device 10 has a fourth driver 41, a fifth driver 42, and a sixth driver 43. The fourth driver 41 drives the elevation angle direction of the first sub-array antenna 11 and the second sub-array antenna 12 of the third antenna C as a whole. The fifth driver 42 drives the elevation angle direction of the third sub-array antenna 13 and the fourth sub-array antenna 14 of the fourth antenna D as a whole. The sixth driver 43 changes the overall azimuth direction of the third antenna C and the fourth antenna D.

In the variation example of the present embodiment, the controller 34, in accordance with the orientation of the third antenna C and the fourth antenna D and the feed state of the second hybrid circuit 22, switches and executes a third mode and a fourth mode. In the third mode, the controller 34 places the third antenna C and the fourth antenna D into the third orientation state. In the third mode, the controller 34, using the second sum signal Σ2 output from the first output terminal 22c of the second hybrid circuit 22 using in-phase feed, performs communication or searching. In the fourth mode, the controller 34 places the third antenna C and the fourth antenna D into the fourth orientation state. In the fourth mode, the controller 34, using the second difference signal Δ2 output from the second output terminal 22d of the second hybrid circuit 22 by opposite-phase feed, captures a party with which communication is to be done or a party to be searched for.

When communicating with a desired party or searching for a desired party, the controller 34 first captures the party with which communication is to be done or the party to be searched for by executing the fourth mode. Next, by executing the third mode, the controller 34 performs communication with or searches for the desired party.

In the variation example of the present embodiment, the array antenna device 10 may have a driver that independently drives the azimuth direction and the elevation direction of each of the four sub-array antennas 11, . . . , 14.

In the variation example of the present embodiment, the controller 34 may perform control, either sequentially or in parallel, the operation of switching the azimuth direction orientation of the first antenna A and the second antenna B and the operation of switching the elevation direction orientation of the third antenna C and the fourth antenna D. The controller 34 may capture a party to be communicated with or to be searched for in the azimuth direction and elevation direction, by using a combination of executing the first mode, the second mode, the third mode, and the fourth mode.

In the above-described embodiment, the radiating elements can be patch antennas, slot antennas, linear antennas, or the like.

In the above-described embodiment, the controller 34 may have a function of executing a program. The program may be recorded in a computer-readable recording medium and may be transmitted via an electrical communication line. The recording medium may be a removable medium such as a flexible disk, an opto-magnetic disk, a ROM, or a CD-ROM, or may be a storage device such as a hard disk built into a computer system.

In the above-described embodiment, a part or all of the functionality of the controller 34 may be implemented by hardware. The hardware is, for example, an LSI (large-scale integration) device, an ASIC (application-specific integrated circuit), a PLD (programmable logic device), or an FPGA (field-programmable gate array).

According to at least one embodiment described above, by having a driver, it is possible to cause the normal lines of reference planes of two sub-array antennas (the first antenna A and second antenna B or the third antenna C and the fourth antenna D) to mutually intersect. By having a feeder (hybrid circuits 21 and 22), it is possible to perform opposite-phase feed of two sub-array antennas with the normal lines of the reference planes of the two sub-array antenna intersecting with each other. By having the driver and the feeder, it is possible to prevent the change and the angle width in response to a null angle appearing in the difference signal by opposite-phase feed of two sub-array antennas from being excessively steep and narrow compared to the mechanical accuracy of the driver. By having the controller 34 it is possible to properly capture a party to be communicated with or to be searched for, when capturing a desired party to communicate accurately with or to search for, using a null in the difference signal by opposite-phase feed of two sub-array antennas. By having the controller 34, compared to when the reference planes of two sub-array antennas form the same plane, it is possible to capture a party to be communicated with or to be searched for using a coarser angle resolution and to suppress the time required for capture from becoming long.

Although a number of embodiments of the present invention are described above, these embodiments are provided as examples, and are not intended to restrict the scope of the invention. These embodiments can be implemented in other various forms and can be subjected to various omissions, replacements, and modifications, within the scope of the spirit of the invention. Just as these embodiments and their variations are included in the scope and spirit of the invention, they are included in the scope of inventions recited in the claims and the equivalents thereto.

1. An array antenna device comprising:
a first sub-array antenna that has a first plurality of radiating elements arranged in a first reference plane;
a second sub-array antenna that has a second plurality of radiating elements arranged in a second reference plane;
a driver that changes the orientation of at least one of the first sub-array antenna and the second sub-array antenna, to cause a first normal line of the first reference plane and a second normal line of the second reference plane to intersect; and
a feeder that performs in-phase power feed to the first sub-array antenna and the second sub-array antenna, and performs opposite-phase power feed to the first sub-array antenna and the second sub-array antenna.

2. The device according to claim 1, wherein the driver changes the orientation of at least one of the first sub-array antenna and the second sub-array antenna to cause that the first and second reference planes to protrude toward the front direction.

3. The device according to claim 1, wherein the driver changes an angle between the reference planes of the first sub-array antenna and the second sub-array antenna within the range from an angle of 180 degrees to a reference angle, and the difference between 180 degrees and the reference angle is in the range between double of the first null angle and double of the second null angle.

4. The device according to claim 3, further comprising:
a controller that switches and executes:
a first mode in which the feeder performs the in-phase power feed in a state that the angle between the first and second reference planes is 180 degrees, and
a second mode in which the feeder performs the opposite-phase feed in a state that the angle between the first and second reference planes is the reference angle.

5. The device according to claim 4, wherein the controller controls the driver to change the orientation to change a directivity of the array antenna device, based on a first signal level obtained from the first sub-array antenna and a second signal level obtained from the second sub-array antenna in executing the second mode.

6. The device according to claim 1, further comprising:
a third sub-array antenna that has a third plurality of radiating elements arranged in a third reference plane; and
a fourth sub-array antenna that has a fourth plurality of radiating elements arranged in a fourth reference plane,
wherein the driver comprises:
a first driver that changes the orientation of at least one of the first sub-array antenna and the second sub-array antenna to change the angle between the first reference plane and the second reference plane into an elevation direction, and the first driver changes the orientation of at least one of the third sub-array antenna and the fourth sub-array antenna to change the angle between the third reference plane and the fourth reference plane into the elevation direction, and
a second driver that changes the orientation of at least one of the first sub-array antenna and the second sub-array antenna to change the angle between the first reference plane and the second reference plane into an azimuth direction, and the second driver changes the orientation of at least one of the third sub-array antenna and the fourth sub-array antenna to change the angle between the third reference plane and the fourth reference plane into the azimuth direction.

7. The device according to claim 2, wherein the driver changes an angle between the reference planes of the first sub-array antenna and the second sub-array antenna within the range from an angle of 180 degrees to a reference angle, and the difference between 180 degrees and the reference angle is in the range between double of the first null angle and double of the second null angle.

8. The device according to claim 7, further comprising:
a controller that switches and executes:
a first mode in which the feeder performs the in-phase power feed in a state that the angle between the first and second reference planes is 180 degrees, and
a second mode in which the feeder performs the opposite-phase feed in a state that the angle between the first and second reference planes is the reference angle.

9. The device according to claim 8, wherein the controller controls the driver to change the orientation to change a directivity of the array antenna device, based on a first signal level obtained from the first sub-array antenna and a second signal level obtained from the second sub-array antenna in executing the second mode.
